(19) United States
(12) Patent Application Publication
(10) Pub. No.: US 2019/0001931 A1
(43) Pub. Date: Jan. 3, 2019

(54) CLEANING UNIT

(71) Applicant: HONDA MOTOR CO., LTD., Tokyo (JP)

(72) Inventors: Koji Okabe, Wako-shi (JP); Kazuma Yoshii, Wako-shi (JP); Taku Kuraishi, Wako-shi (JP); Atsushi Suenaga, Wako-shi (JP); Koya Sugawara, Wako-shi (JP); Nobuyuki Akahoshi, Wako-shi (JP)

(21) Appl. No.: 15/989,463

(22) Filed: May 25, 2018

(30) Foreign Application Priority Data
Jun. 28, 2017 (JP) 2017-126472

(51) Int. Cl. B60S 1/56; B60S 1/50; B60S 1/48; B08B 3/10; B08B 3/02

(52) U.S. Cl. CPC B60S 1/56; B60S 1/50; B08B 3/02; B08B 3/10; B60S 1/487

(57) ABSTRACT

The present invention provides a cleaning unit that is attached to a vehicle and cleans an outer lens configured to cover a light source for illuminating an outer side of the vehicle and form part of an outer surface of the vehicle, the cleaning unit including a tank configured to reserve a washer fluid for cleaning the outer lens, and a supply unit provided above the outer lens and configured to supply the washer fluid reserved in the tank by dropping the washer fluid on the outer lens.

### BACKGROUND OF THE INVENTION

### Field of the Invention

The present invention relates to a cleaning unit.

### Description of the Related Art

In a vehicle represented by a four-wheeled vehicle, generally, headlights or headlamps configured to illuminate the front side of the vehicle are provided on the left and right sides of the front surface of the vehicle. Since an outer lens forming each headlight forms part of the outer surface of the vehicle, dirt, snow, or ice may attach to the surface or condensation (fogging) may occur on the surface. To cope with this, Japanese Patent Laid-Open No. 2006-199201 proposes a technique of removing dirt, snow, or ice attached to the outer lens or condensation occurring on the outer lens, that is, cleaning each headlight, by spraying a washer fluid to each outer lens. Japanese Patent Laid-Open No. 2006-199201 discloses a technique of removing snow or ice attached to each headlight by arranging a heater between a reservoir tank that reserves the washer fluid and a nozzle head that sprays the washer fluid toward each outer lens, and spraying, to each outer lens, the washer fluid heated by the heater.

However, as in the technique disclosed in Japanese Patent Laid-Open No. 2006-199201, a cleaning unit that cleans each headlight generally operates the nozzle head by the water pressure of the washer fluid (sprays the washer fluid). Therefore, a dedicated high pressure pump is required to pressure-feed the washer fluid from the reservoir tank to the nozzle head.

### SUMMARY OF THE INVENTION

The present invention efficiently cleans each outer lens with a simple arrangement.

According to the present invention, there is provided a cleaning unit that is attached to a vehicle and cleans an outer lens configured to cover a light source for illuminating an outer side of the vehicle and form part of an outer surface of the vehicle, the cleaning unit including a tank configured to reserve a washer fluid for cleaning the outer lens, and a supply unit provided above the outer lens and configured to supply the washer fluid reserved in the tank by dropping the washer fluid on the outer lens.

Further objects or other aspects of the present invention will become apparent from a preferred embodiment to be described below with reference to the accompanying drawings.

### BRIEF DESCRIPTION OF THE DRAWINGS

FIG. 1 is a schematic view showing the arrangement of a vehicle including a cleaning unit according to an aspect of the present invention.

FIG. 2 is a view for explaining the overall arrangement of the cleaning unit of the vehicle shown in FIG. 1.

FIG. 3 is a perspective view showing the supply unit of the cleaning unit of the vehicle shown in FIG. 1 when viewed from the front side of the vehicle.

FIG. 4 is a perspective view showing the supply unit of the cleaning unit of the vehicle shown in FIG. 1 when viewed from the back side of a front hood.

FIG. 5 is a view showing support members provided in the vehicle shown in FIG. 1.

### DESCRIPTION OF THE EMBODIMENTS

A preferred embodiment of the present invention will be described below with reference to the accompanying drawings. Note that the same reference numerals denote the same members throughout the drawings, and a repetitive description will be omitted.

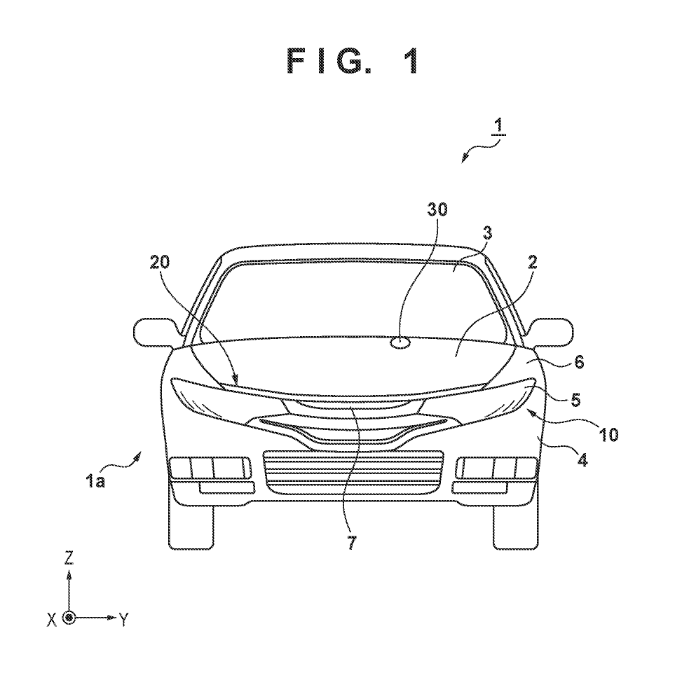

FIG. 1 is a schematic view showing the arrangement of a vehicle 1 including a cleaning unit 20 according an aspect of the present invention. FIG. 1 shows the front (front surface 1a) of the vehicle 1. The vehicle 1 is, for example, a four-door sedan type four-wheeled vehicle. However, the present invention is also applicable to a four-wheeled vehicle other than the sedan type or a vehicle of another type. Note that in FIG. 1, a coordinate axis X represents the longitudinal direction of the vehicle, a coordinate axis Y represents the vehicle width direction of the vehicle 1, and a coordinate axis Z represents the vertical direction of the vehicle 1.

The vehicle 1 is roughly divided into a front portion, a middle portion, and a rear portion. For example, driving units such as an engine and a transmission are stored in the front portion of the vehicle 1. The front portion of the vehicle 1 includes a front hood 2 as an exterior (outer surface) that covers the internal storage space. A cowl between the front hood 2 and a windshield 3 is provided with a washer nozzle 30, the bases of wipers, and the inlet of a ventilator. On the front surface 1a of the vehicle 1, a front bumper 4 serving as a buffer portion that reduces and absorbs the impact of a collision is provided on the lower side of the front hood 2. Additionally, the front bumper 4, headlight units 10 that illuminate the front side (outer side) of the vehicle 1, and the cleaning unit 20 that cleans each headlight unit 10 are provided on the front surface 1a of the vehicle 1. The middle portion of the vehicle 1 forms, for example, a cabin. The rear portion of the vehicle 1 forms, for example, a trunk.

The headlight units 10 are attached to two, left and right portions of the front surface 1a of the vehicle 1. The headlight units 10 are arranged on the lower side of the front hood 2 and a fender 6 and on the upper side of the front bumper 4, that is, between the front bumper 4 and the front hood 2 and fender 6, to be adjacent to a front grille 7. Each headlight unit 10 includes an outer lens 5 as a cover member that covers a light source configured to illuminate the front side of the vehicle 1, and the like. The outer lens 5 forms part of the outer surface of the vehicle 1. The outer lens 5 is made of a translucent material with an excellent durability to an external impact and weather.

The cleaning unit 20 has a function of cleaning each headlight unit 10. In this embodiment, the cleaning unit 20 is attached to the vehicle 1 as a unit that removes dirt, snow, or ice attached to each outer lens or condensation occurring on each outer lens, that is, cleaning each outer lens 5.

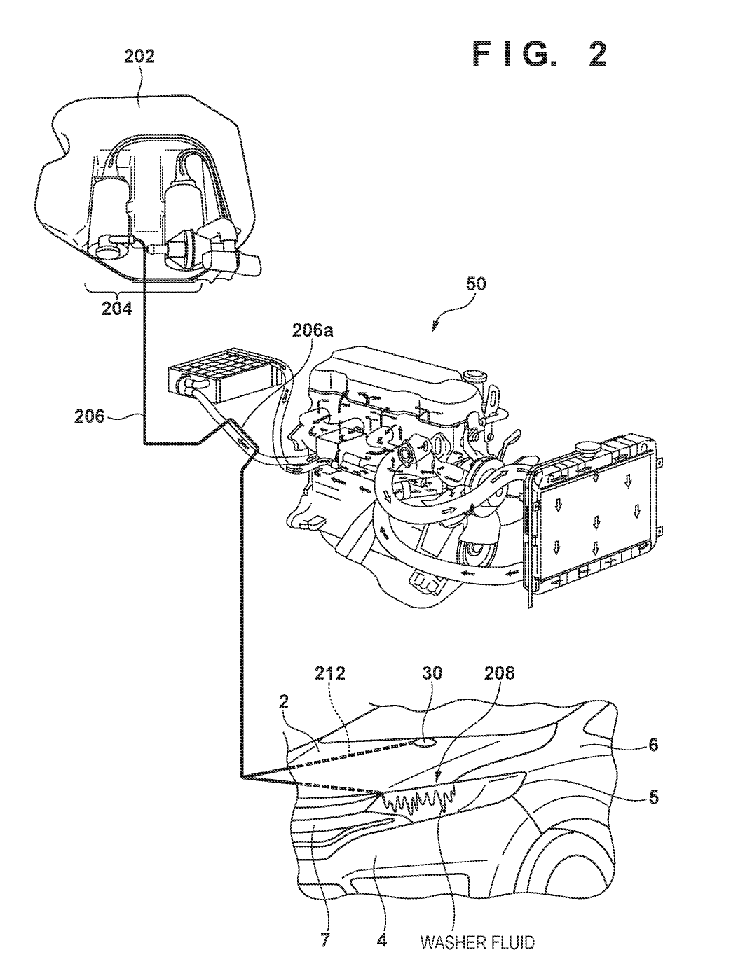

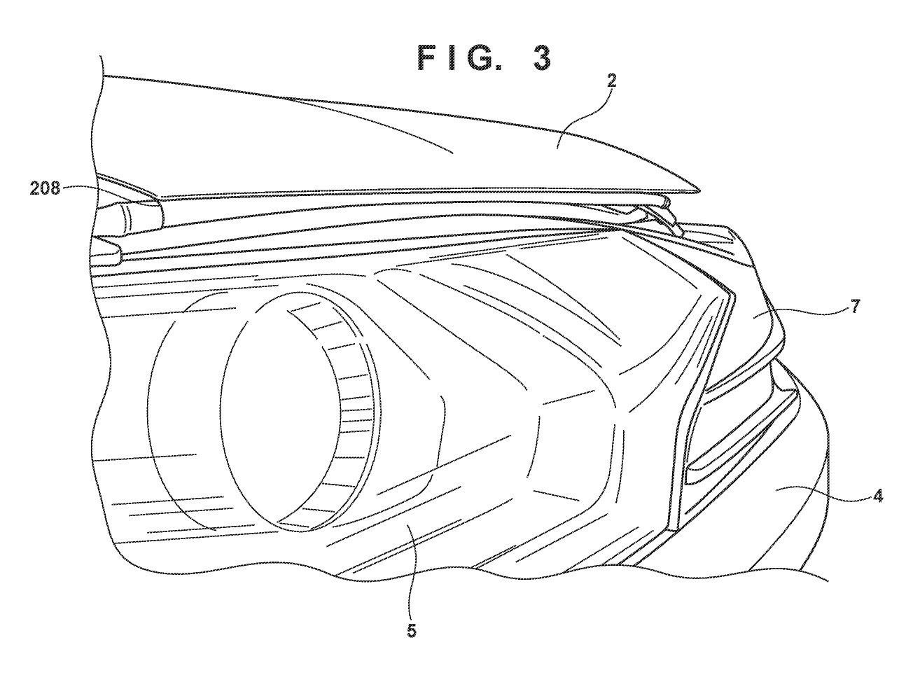

As shown in FIGS. 2 and 3, the cleaning unit 20 includes a tank 202, a feed unit 204, a supply path 206, and a supply unit 208. FIG. 2 is a view for explaining the overall arrangement of the cleaning unit 20. FIG. 3 is a perspective view showing the supply unit 208 of the cleaning unit 20 when viewed from the front side of the vehicle 1.

The tank 202 is a container that reserves (stores) a washer fluid for cleaning each outer lens 5, and is basically stored in the front portion of the vehicle 1, that is, the storage space covered with the front hood 2. The washer fluid is a fluid that can remove dirt, snow, ice, or condensation attached to each outer lens 5 and does not damage each outer lens 5, and is, for example, a fluid containing a surfactant, methanol, ultrapure water, or the like. The tank 202 has, for example, a capacity of 2 to 3 liters. As will be described later, however, if the washer fluid is shared to clean each outer lens 5 and the windshield 3, the tank 202 has a capacity of 5 to 10 liters.

The feed unit 204 has a function of feeding the washer fluid reserved in the tank 202 to the supply unit 208. In this embodiment, the feed unit 204 includes a pump, and pressure-feeds the washer fluid reserved in the tank 202 to the supply path 206. The supply path 206 is a passage that connects the tank 202 and the supply unit 208 to supply the washer fluid from the tank 202 to the supply unit 208. In this way, the feed unit 204 supplies the washer fluid reserved in the tank 202 to the supply unit 208 through the supply path 206.

The supply unit 208 is provided above the outer lenses 5, in this embodiment, between the front hood 2 and the front bumper 4 and outer lenses 5. The supply unit 208 supplies the washer fluid supplied from the tank 202 through the supply path 206 by dropping the washer fluid on each outer lens 5 by gravity. When the washer fluid supplied to each outer lens 5 flows on the surface of each outer lens 5, dirt, snow, ice, or condensation attached to each outer lens 5 is removed (that is, each outer lens 5 is cleaned).

As described above, in this embodiment, the washer fluid is dropped from above each outer lens 5 to clean each outer lens 5 instead of spraying the washer fluid to each outer lens 5. Since, therefore, it is possible to suppress the pressure low when the feed unit 204 feeds (pressure-feeds) the washer fluid to the supply unit 208, it is unnecessary to use a high pressure pump for the feed unit 204, and each outer lens 5 can be cleaned with a simple arrangement. In particular, when cleaning each outer lens 5 during traveling of the vehicle 1, the washer fluid flows on the surface of each outer lens 5 while being pressed against each outer lens 5 by the pressure of traveling wind, thereby improving the cleaning effect of each outer lens 5.

In addition, as described above, an engine 50 is stored in the front portion of the vehicle 1, that is, the storage space covered with the front hood 2. The engine 50 burns fuel in it (in a cylinder), and thus serves as a heat source during traveling of the vehicle 1. Thus, as shown in FIG. 2, a portion 206a of the supply path 206 is kept in contact with a portion (for example, a pipe) of the engine 50 to make the engine 50 function as a heating unit that heats the washer fluid supplied from the tank 202 to the supply unit 208. This allows the supply unit 208 supply the washer fluid heated by the engine 50 by dropping the washer fluid on each outer lens 5, and it is possible to melt snow or ice attached to each outer lens 5, thereby obtaining an advantage in removing snow or ice.

Note that it is possible to heat the washer fluid to an appropriate temperature (for example, a temperature at which snow or ice is melted and each outer lens 5 is not damaged) by adjusting the area of the portion 206a of the supply path 206, which is in contact with the engine 50. In this embodiment, the engine 50 is made to function as the heating unit that heats the washer fluid. The present invention, however, is not limited to this. For example, the heating unit that heats the washer fluid supplied from the tank 202 to the supply unit 208 may be additionally provided between the tank 202 and the supply unit 208.

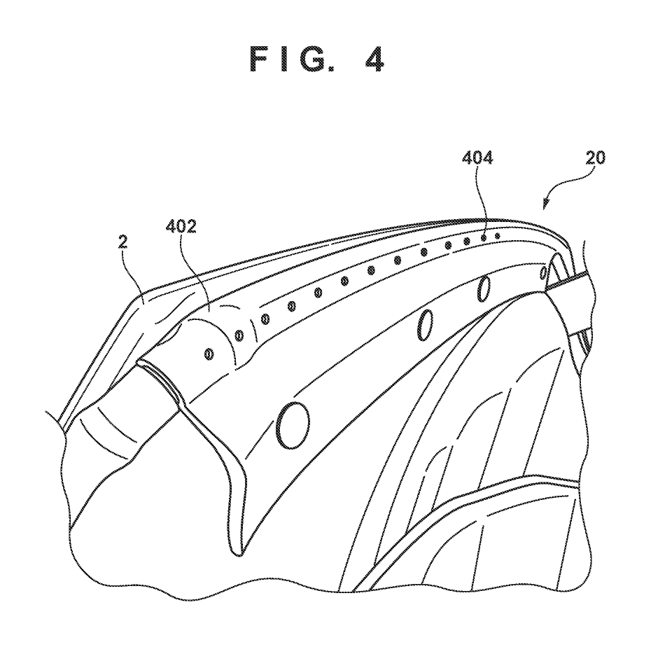

The detailed arrangement of the supply unit 208 will be described with reference to FIG. 4. FIG. 4 is a perspective view showing the supply unit 208 of the cleaning unit 20 when viewed from the back side of the front hood 2 of the vehicle 1. As shown in FIG. 4, the supply unit 208 includes a cylindrical member 402 extending along the front end of the front hood 2 (the upper edges of the outer lenses 5) and supply holes (small holes) 404 formed in the cylindrical member 402. One end of the cylindrical member 402 is connected to the supply path 206. Therefore, the washer fluid reserved in the tank 202 is supplied into the cylindrical member 402 through the supply path 206, and leaks out from the cylindrical member 402 via the supply holes 404. The washer fluid leaking out from the cylindrical member 402 falls (drops) toward each outer lens 5 by gravity. Therefore, this simple arrangement can implement the supply unit 208 that drops the washer fluid from above each outer lens 5.

In this embodiment, to supply the washer fluid to the entire surface of each outer lens 5, a number of supply holes 404 are formed at equal intervals in the vehicle width direction over a region of the cylindrical member 402 corresponding to the upper edge of each outer lens 5. However, it is only necessary to form the supply holes 404 in the cylindrical member 402 so as to supply the washer fluid to the entire surface of each outer lens 5. The region and location of the cylindrical member 402 where the supply holes 404 are formed, the number of supply holes 404, a hole diameter, and an interval are not limited.

The cylindrical member 402 is configured to seal a portion between the vehicle 1 and the front hood 2 by abutting against a portion corresponding to the front end of the front hood 2 of the vehicle 1 while the front hood 2 is closed. The vehicle 1 is provided with a hood seal that seals a portion between the vehicle 1 and the front hood 2 in order to prevent the front hood 2 from opening during traveling when traveling wind enters the portion between the vehicle 1 and the front hood 2. The hood seal is provided along the front end of the front hood 2 for the application purpose. Therefore, by providing the cylindrical member 402 in the hood seal, that is, forming the cylindrical member 402 integrally with the hood seal, it is possible to reduce the number of parts of the vehicle 1, thereby obtaining an advantage in cost.

If the hood seal is formed by a hollow seal, the cylindrical member 402 is preferably formed by the hood seal. By forming the cylindrical member 402 using the hollow seal forming the hood seal in this way, it is possible to implement the supply unit 208 with the simple arrangement.

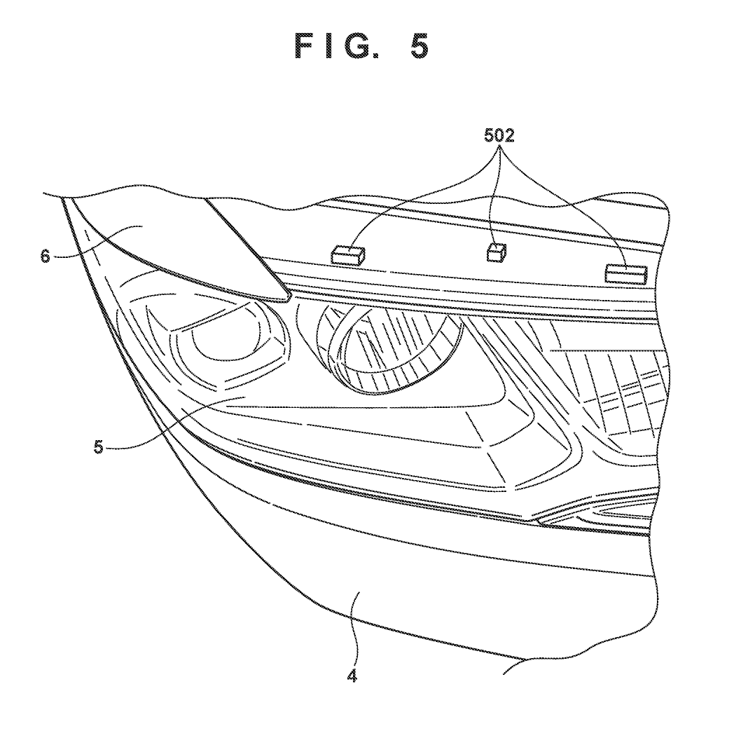

Even in a state in which the front hood 2 is closed, the cylindrical member 402 needs to be prevented from being completely crushed (that is, needs to maintain a predetermined inner diameter) so that the washer fluid flows through the cylindrical member 402. To achieve this, in this embodiment, as shown in FIG. 5, support members 502 that support the cylindrical member 402 are provided in the portion corresponding to the front end of the front hood 2 of the vehicle 1. The number of support members 502 and their arrangement positions are set so that the cylindrical member 402 maintains the predetermined inner diameter when the support members 502 support the cylindrical member 402. FIG. 5 is a view showing the support members 502 provided in the vehicle 1 in a state in which the front hood 2 is open.

Furthermore, the vehicle 1 is provided with the washer nozzle 30 for cleaning the windshield 3 by spraying the washer fluid to the windshield 3. In this embodiment, the washer fluid reserved in the tank 202 can also be used as the washer fluid for cleaning the windshield 3. In this case, as shown in FIG. 2, a branch path 212 that connects the supply path 206 and the washer nozzle 30 and supplies, to the washer nozzle 30, the washer fluid supplied to the supply path 206 is formed. Thus, since the one feed unit 204 can supply the washer fluid to both the supply unit 208 and the washer nozzle 30, this arrangement contributes to further simplification of the arrangement of the vehicle 1. Furthermore, by providing the branch path 212 at the succeeding stage of the heating unit (the portion 206a of the supply path 206, which is in contact with the engine 50) that heats the washer fluid supplied from the tank 202 to the supply unit 208, it is possible to supply the washer fluid heated by the heating unit to the washer nozzle 30.

Note that in this embodiment, the feed unit 204 includes the pump. This is because, as described above, the washer fluid is shared to clean each outer lens 5 and the windshield 3 (that is, it is necessary to spray the washer fluid from the washer nozzle 30). Therefore, if the washer fluid is not shared to clean each outer lens 5 and the windshield 3, the feed unit 204 need not always include the pump as long as the feed unit 204 can feed the washer fluid to the supply unit 208. In this case, for example, the tank 202 is arranged above the supply unit 208 to feed the washer fluid from the feed unit 204 to the supply unit 208 by gravity.

### Summary of Embodiment

1. A cleaning unit according to the above-described embodiment is a cleaning unit (for example, 20) that is attached to a vehicle (for example, 1) and cleans an outer lens (for example, 5) configured to cover a light source for illuminating an outer side of the vehicle and form part of an outer surface of the vehicle, the cleaning unit comprising:

a tank (for example, 202) configured to reserve a washer fluid for cleaning the outer lens; and

a supply unit (for example, 208) provided above the outer lens and configured to supply the washer fluid reserved in the tank by dropping the washer fluid on the outer lens.

According to this embodiment, since the washer fluid supplied from the tank to the supply unit can be supplied by being dropped on the outer lens by gravity, it is possible to clean the outer lens with a simple arrangement.

2. The cleaning unit (for example, 20) according to the above-described embodiment further comprising a heating unit (for example, 50, 206a) provided between the tank (for example, 202) and the supply unit (for example, 208) and configured to heat the washer fluid supplied from the tank to the supply unit.

According to this embodiment, it is possible to supply the washer fluid heated by the heating unit by dropping it on the outer lens, thereby obtaining an advantage in removing snow or ice attached to the outer lens.

3. The cleaning unit (for example, 20) according to the above-described embodiment,
wherein the supply unit (for example, 208) includes a cylindrical member (for example, 402) extending along an upper edge of the outer lens (for example, 5) and a supply hole (for example, 404) formed in the cylindrical member,

the washer fluid reserved in the tank (for example, 202) is supplied into the cylindrical member, and

the supply unit supplies the washer fluid supplied into the cylindrical member by dropping the washer fluid on the outer lens via the supply hole.

According to this embodiment, it is possible to implement the supply unit that drops the washer fluid from above the outer lens with a simple arrangement.

4. The cleaning unit (for example, 20) according to the above-described embodiment, wherein the cylindrical member (for example, 402) is provided along a front end of a hood (for example, 2) provided above the outer lens (for example 5) of the vehicle (for example, 1).

5. The cleaning unit (for example, 20) according to the above-described embodiment, wherein the cylindrical member (for example, 402) abuts against the vehicle (for example, 1) to seal a portion between the vehicle and the hood (for example 2).

According to this embodiment, it is possible to form the cylindrical member integrally with the hood seal, thereby obtaining an advantage in cost.

6. The cleaning unit (for example, 20) according to the above-described embodiment, further comprising a supply path (for example, 206) configured to connect the tank (for example, 202) and the supply unit (for example, 208) and supply the washer fluid from the tank to the supply unit,

wherein the supply path includes, between the heating unit and the supply unit, a branch path (for example, 212) configured to supply the washer fluid reserved in the tank to a nozzle (for example, 30) configured to spray the washer fluid to a windshield (for example, 3) of the vehicle (for example, 1).

According to this embodiment, since it is possible to supply the washer fluid to both the supply unit and the washer nozzle, this arrangement contributes to simplification of the arrangement of the vehicle.

7. The cleaning unit (for example, 20) according to the above-described embodiment, wherein the cylindrical member is provided in a hood seal provided along the front end of the hood of the vehicle.

According to this embodiment, it is possible to form the cylindrical member integrally with the hood seal, thereby obtaining an advantage in cost.

8. The cleaning unit (for example, 20) according to the above-described embodiment,

wherein the hood seal includes a hollow seal configured to abut against the vehicle to seal a portion between the vehicle and the hood (for example, 2), and

the cylindrical member (for example, 402) is formed by the hollow seal.

According to this embodiment, it is possible to implement the supply unit with a simple arrangement by forming the cylindrical member using the hollow seal.

The preferred embodiment of the present invention has been described above. However, the present invention is not limited to this embodiment, as a matter of course, and various changes and modifications can be made within the scope of the present invention.

What is claimed is:

1. A cleaning unit that is attached to a vehicle and cleans an outer lens configured to cover a light source for illuminating an outer side of the vehicle and form part of an outer surface of the vehicle, the cleaning unit comprising:
a tank configured to reserve a washer fluid for cleaning the outer lens; and
a supply unit provided above the outer lens and configured to supply the washer fluid reserved in the tank by dropping the washer fluid on the outer lens.

2. The unit according to claim 1, further comprising a heating unit provided between the tank and the supply unit and configured to heat the washer fluid supplied from the tank to the supply unit.

3. The unit according to claim 1,
wherein the supply unit includes a cylindrical member extending along an upper edge of the outer lens and a supply hole formed in the cylindrical member,
the washer fluid reserved in the tank is supplied into the cylindrical member, and
the supply unit supplies the washer fluid supplied into the cylindrical member by dropping the washer fluid on the outer lens via the supply hole.

4. The unit according to claim 3, wherein the cylindrical member is provided along a front end of a hood provided above the outer lens of the vehicle.

5. The unit according to claim 4, wherein the cylindrical member abuts against the vehicle to seal a portion between the vehicle and the hood.

6. The unit according to claim 2, further comprising a supply path configured to connect the tank and the supply unit and supply the washer fluid from the tank to the supply unit,
wherein the supply path includes, between the heating unit and the supply unit, a branch path configured to supply the washer fluid reserved in the tank to a nozzle configured to spray the washer fluid to a windshield of the vehicle.

7. The unit according to claim 4, wherein the cylindrical member is provided in a hood seal provided along the front end of the hood of the vehicle.

8. The unit according to claim 7,
wherein the hood seal includes a hollow seal configured to abut against the vehicle to seal a portion between the vehicle and the hood, and
the cylindrical member is formed by the hollow seal.
